(19) United States
(12) Patent Application Publication
(10) Pub. No.: US 2024/0132706 A1
(43) Pub. Date: Apr. 25, 2024

(54) RUBBER COMPOSITION FOR TIRES AND TIRE

(71) Applicant: SUMITOMO RUBBER INDUSTRIES, LTD., Kobe-shi (JP)

(72) Inventor: Yuki MATSUZAWA, Kobe-shi (JP)

(73) Assignee: SUMITOMO RUBBER INDUSTRIES, LTD., Kobe-shi (JP)

(21) Appl. No.: 18/538,739

(22) Filed: Dec. 13, 2023

(51) Int. Cl. C08L 9/06; B60C 1/00

(52) U.S. Cl. CPC C08L 9/06; B60C 1/00

(57) ABSTRACT

The present invention provides a rubber composition for tires and a tire that can exhibit sufficient ozone resistance even if not containing paraphenylenediamine-based compound that has excellent ozone resistance; and relates to a rubber composition for tires which contains 90 parts by mass or more of a hydrogenated polymer with a hydrogenation rate of 90 mol % or more in 100 parts by mass of the rubber component; and 50 parts by mass or more of a filler and 10 parts by mass or more of a plasticizer with respect to 100 parts by mass of the rubber component; and does not contain a paraphenylenediamine-based compound, and a tire which has a member made of the rubber composition for tires.

### TECHNICAL FIELD

The present invention relates to a rubber composition for tires and a tire having a member made of the rubber composition.

### BACKGROUND ART

In WO2016/039008 A (Patent document 1 mentioned below), techniques for incorporating hydrogenated polymers to improve abrasion resistance are disclosed.

### PRIOR ART DOCUMENTS

### Patent Document

[Patent document 1] EP3181630A1

### SUMMARY OF INVENTION

### Problem to be Solved by the Invention

In Patent Document 1, a PPD (p-phenylenecliamine)-based anti-aging agent is contained in a rubber composition for tire for ozone resistance performance.

The purpose of the present invention is to provide a rubber composition for tires that can exhibit sufficient ozone resistance performance even if it does not contain a PPD-based compound that has excellent ozone resistance performance, and a tire having a member made of the rubber composition.

### Means for Solving the Problem

The present invention relates to a rubber composition for tires comprising
90 parts by mass or more of a hydrogenated polymer with a hydrogenation rate of 90 mol % or more in 100 parts by mass of the rubber component;
50 parts by mass or more of a filler with respect to 100 parts by mass of the rubber component, and
parts by mass or more of a plasticizer with respect to 100 parts by mass of the rubber component; wherein
the rubber composition contains no paraphenylenethamine-based compound;
and a tire having a member made of the rubber composition.

### Effect of the Invention

According to the present invention, even if a PPD-based compound having excellent ozone resistance performance is not contained, sufficient ozone resistance performance can be exhibited.

### EMBODIMENTS FOR CARRYING OUT THE INVENTION

The tire rubber composition of the present invention contains 90 parts by mass or more of a hydrogenated polymer with a hydrogenation rate of 90 mol % or more in 100 parts by mass of the rubber component. Further, 50 parts by mass or more of a filler and 10 parts by mass or more of a plasticizer are contained with respect to 100 parts by mass of the rubber component. As a result, even if the PPD-based compound, which has excellent ozone resistance performance, is not contained, it is possible to exhibit sufficient ozone resistance performance.

The hydrogenated polymer is a hydrogenated product of a polymer of a conjugated diene compound, a hydrogenated product of a copolymer of a conjugated diene compound and an aromatic vinyl compound, or a hydrogenated product of a mixture thereof. Among them, a hydrogenated product of copolymer of a conjugated diene compound and an aromatic vinyl compound (a hydrogenated copolymers) is preferred. Examples of the conjugated diene compound include 1,3-butacliene, isoprene, 1,3-pentacliene, 2,3-dimethylbutacliene, 2-phenyl-1,3-butadiene, and 1,3-hexacliene. These may be used alone or in combination of two or more. Among them, 1,3-butadiene and isoprene are preferred, and 1,3-butadiene is more preferred, from a practical view point such as monomer availability. Examples of aromatic vinyl compounds include styrene, α-methylstyrene, 1-vinylnaphthalene, 3-vinyltoluene, ethylvinylbenzene, divinylbenzene, 4-cyclohexylstyrene, and 2,4,6-trimethylstyrene. These may be used alone or in combination of two or more. Among them, styrene is particularly preferred from the practical view point of monomer availability.

As the copolymer of an aromatic vinyl compound and a conjugated diene compound, a copolymer of styrene and 1,3-butadiene (styrene-butadiene copolymer, SBR) is preferable. Therefore, as the hydrogenated copolymer, hydrogenated styrene-butadiene copolymer (hydrogenated SBR) is preferable. Further, the hydrogenated styrene-butadiene copolymer (hydrogenated SBR) is preferably a hydrogenated modified styrene-butadiene copolymer modified by the method described below.

The above styrene-butadiene copolymer (SBR) is not particularly limited in the order of copolymerization as long as styrene and 1,3-butadiene are copolymerized, and random copolymerization or block copolymerization may be used, but random copolymerization is preferable. The same applies to a copolymer of an aromatic vinyl compound and a conjugated diene compound other than styrene-butadiene copolymers (SBR).

The hydrogenation rate in hydrogenated SBR (the hydrogenated ratio to the conjugated diene portion of the copolymer of an aromatic vinyl compound (styrene) and a conjugated diene compound (butadiene)) is 90 mol % or more. The hydrogenation rate is preferably 92 mol % or more, more preferably 94 mol % or more, and the upper limit is 100 mol %. Note that the hydrogenation rate can be calculated from the spectral reduction rate of unsaturated bonds in the spectrum obtained by measuring H¹-NMR.

The weight average molecular weight (Mw) of hydrogenated SBR is preferably 200,000 or more, and more preferably 400,000 or more. If Mw is less than 200,000, good rubber tensile strength and good abrasion resistance may not be obtained. Moreover, the Mw of hydrogenated SBR is preferably 2,000,000 or less, more preferably 1,000,000 or less, and further preferably 700,000 or less. When the Mw is more than 2,000,000, processability tends to decrease.

Herein, the weight average molecular weight (Mw) and the number average molecular weight (Mn) can be determined by gel permeation chromatography (GPC) (GPC-8000 series available from Tosoh Corporation, detector: differential refractometer, column: TSKGEL SUPERMULTIPORE HZ-M available from Tosoh Corporation) relative to polystyrene standards.

The hydrogenated SBR preferably has a glass transition temperature (Tg) of −90° C. or higher, more preferably −80° C. or higher, and further preferably −75° C. or higher. The Tg of the hydrogenated SBR is also preferably lower than −10° C., more preferably lower than −12.5° C., further preferably lower than −15° C., and particularly preferably lower than −20° C.

The glass transition temperature (Tg) of the hydrogenated SBR is measured as described in the Examples later.

The styrene content of hydrogenated SBR is preferably 5% by mass or more, more preferably 10% by mass or more, and further preferably 15% by mass or more. The styrene content of the hydrogenated SBR is also preferably 40% by mass or less, more preferably 35% by mass or less. The styrene content is measured as described in the Examples later.

The above-mentioned hydrogenated SBR may be synthesized, for example, by hydrogenating a polymer (styrene-butadiene copolymer: SBR) obtained by polymerization of an aromatic vinyl compound (styrene) and a conjugated diene compound (butadiene). Specifically, it can be synthesized by the following method.

### <Method for Producing Styrene Butadiene Copolymer (SBR)>

### (Polymerization Method)

The copolymer (styrene-butadiene copolymer: SBR) of an aromatic vinyl compound (styrene) and a conjugated diene compound (butadiene) may be polymerized by any method, including solution polymerization, vapor phase polymerization, and bulk polymerization, and particularly preferably by solution polymerization. The polymerization may be carried out in a batch mode or in a continuous mode.

When a solution polymerization method is used, the monomer concentration (the combined concentration of styrene and 1,3-butadiene) in the solvent is preferably 5% by mass or more, more preferably 10% by mass or more. When the monomer concentration in the solvent is less than 5% by mass, the content of styrene-butadiene copolymer (SBR) obtained tends to be small, resulting in increased cost. The monomer concentration in the solvent is also preferably 50% by mass or less, more preferably 30% by mass or less. When the monomer concentration in the solvent is more than 50% by mass, the solution tends to become too viscous to stir easily, and thus polymerization tends not to occur easily.

### (Polymerization Initiator in Anionic Polymerization)

In the case of anionic polymerization in a solution polymerization method, any type of polymerization initiator may be used, but preferred are organic lithium compounds. The organic lithium compound is preferably one containing a C2-C20 alkyl group, and examples include ethyllithium, n-propyllithium, isopropyllithium, n-butyllithium, sec-butyllithium, tert-butyllithium, tert-octyllithium, n-decyllithium, phenyllithium, 2-naphthyllithium, 2-butyl-phenyllithium, 4-phenyl-butyllithium, cyclohexyllithium, cyclopentyllithium, and reaction products of diisopropenylbenzene and butyllithium. In view of availability, safety, and other aspects, n-butyllithium or sec-butyllithium is preferred among these.

The polymerization reaction may be carried out in the presence of a compound (R) obtained by mixing at least one of the organic lithium compounds mentioned above with a compound (B1) containing a functional group interactive with silica. When the polymerization is carried out in the presence of the compound (R), a functional group interactive with silica is introduced to the polymerization initiating terminal of a styrene-butadiene copolymer (SBR). As a result, a styrene-butadiene copolymer (SBR) has a modified polymerization initiating terminal. The term “interactive” herein means the formation of a covalent bond or an intermolecular force weaker than covalent bonds (e.g. electromagnetic forces between molecules such as ion-dipole interaction, dipole-dipole interaction, hydrogen bond, or van der Waals force) between molecules. The term “functional group interactive with silica” herein refers to a group having at least one atom interactive with silica such as a nitrogen atom, a sulfur atom, a phosphorus atom, or an oxygen atom.

The above compound (R) is preferably a reaction product of an organic lithium compound and a nitrogen-containing compound such as a secondary amine compound, among others. Specific examples of the nitrogen-containing compound include dimethylamine, diethylamine, dipropylamine, dibutylamine, dodecamethyleneimine, N,N′-dimethyl-N′-trimethylsilyl-1,6-diaminohexane, piperidine, pyrrolidine, hexamethyleneimine, heptamethyleneimine, dicyclohexylamine, N-methylbenzylamine, di-(2-ethylhexyl)amine, thallylamine, morpholine, N-(trimethylsilyl)piperazine, N-(tert-butyldimethylsilyl)piperazine, and 1,3-ditrimethylsilyl-1,3,5-triazinane. Polymerization in the presence of the compound (R) may be carried out by preliminarily mixing an organic lithium compound with a compound (B1) to prepare a compound (R), and adding the compound (R) to the polymerization system followed by polymerization. Alternatively, it may be carried out by adding an organic lithium compound and a compound (B1) to the polymerization system and mixing them in the polymerization system to prepare a compound (R) followed by polymerization.

### (Method for Anionic Polymerization)

The production of a styrene-butadiene copolymer (SBR) through anionic polymerization using the polymerization initiator may be carried out by any method including conventionally known methods.

Specifically, styrene and 1,3-butadiene, for example, may be anionically polymerized in an organic solvent inert to the reaction, for example, a hydrocarbon solvent such as an aliphatic, alicyclic, or aromatic hydrocarbon compound, using a polymerization initiator such as butyllithium, optionally in the presence of a randomizer to produce a styrene-butadiene copolymer (SBR).

### (Hydrocarbon Solvent in Anionic Polymerization)

The hydrocarbon solvent is preferably a C3-C8 hydrocarbon solvent, and examples include propane, n-butane, isobutane, n-pentane, isopentane, n-hexane, cyclohexane, propene, 1-butene, isobutene, trans-2-butene, cis-2-butene, 1-pentene, 2-pentene, 1-hexene, 2-hexene, benzene, toluene, xylene, and ethylbenzene. Each of these may be used alone, or two or more of these may be used in combination.

### (Randomizer in Anionic Polymerization)

The randomizer refers to a compound that has the function of controlling the microstructure of the conjugated diene units of a styrene-butadiene copolymer (SBR), for example, 1,2-bond in butadiene units, or the function of controlling the compositional distribution of monomer units in a styrene-butadiene copolymer (SBR), for example, randomization of styrene units and butadiene units in a styrene-butadiene copolymer. The randomizer is not particularly limited, and any compound commonly and conventionally used as randomizer may be used. Examples include ethers and tertiary amines, such as dimethoxybenzene, tetrahydrofuran, dimethoxyethane, diethylene glycol dibutyl ether, diethylene glycol dimethyl ether, bis(tetrahydrofuryl)propane, triethylamine, pyridine, N-methylmorpholine, N,N,N′,N′-tetramethylethylenethamine, and 1,2-dipiperidinoethane. Other examples include potassium salts such as potassium-t-amylate or potassium-t-butoxide; and sodium salts such as sodium-t-amylate. Each of these randomizers may be used alone, or two or more of these may be used in combination. The amount of the randomizer to be used per mol of the organic lithium compound is preferably 0.01 mole equivalents or more, more preferably 0.05 mole equivalents or more. When the amount of the randomizer is less than 0.01 mole equivalents, the effect of the added randomizer tends to be small, and thus randomization tends not to occur easily. The amount of the randomizer per mol of the organic lithium compound is also preferably 1,000 mole equivalents or less, more preferably 500 mole equivalents or less. When the amount of the randomizer is more than 1,000 mole equivalents, the reaction rate of monomers tends to change greatly, and as a result randomization tends to fail to occur easily as expected.

The Tg of the styrene-butadiene copolymer (SBR) can be adjusted by controlling the type or amount of the randomizer. For example, the Tg of the styrene-butadiene copolymer (SBR) can be lowered by decreasing the amount of tetrahydrofuran.

### (Reaction Temperature)

The reaction temperature during anionic polymerization is not particularly limited as long as the reaction suitably proceeds. Usually, the reaction temperature is preferably −10° C. to 100° C., more preferably 25° C. to 70° C.

### (Modification Step)

A functional group interactive with silica can be introduced to the polymerization terminating terminal of the styrene-butadiene copolymer (SBR) obtained by the above polymerization step by the step of reacting the active terminal of the styrene-butadiene copolymer (SBR) with a compound (B2) containing a functional group interactive with silica. As a result, the styrene-butadiene copolymer (SBR) in which the terminating terminal is modified can be obtained. The term “terminal” herein refers to an end portion of the molecular chain, excluding monomer-derived structures containing carbon-carbon double bonds.

The styrene-butadiene copolymer (SBR) used in the above modification reaction (hereinafter also referred to as terminal modification reaction) may be any copolymer which has an active terminal either with a modified or unmodified polymerization initiating terminal. The compound (B2) may be any compound which contains a functional group interactive with silica and is reactable with the polymerization active terminal. Preferable specific examples of the compound (B2) include:
(I) a compound (B2-1) represented by the following Formula (1):

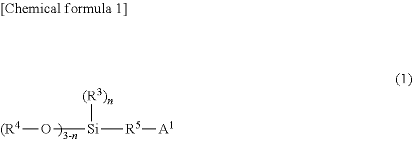

in Formula (1), A¹ represents a monovalent functional group which contains no active hydrogen, but contains at least one selected from the group consisting of a nitrogen atom, a phosphorus atom, and a sulfur atom, and is bound to R⁵ through a nitrogen atom, a phosphorus atom, or a sulfur atom; R³ and R⁴ each represent a hydrocarbyl group; R⁵ represents a hydrocarbylene group; and n represents an integer of 0 to 2, provided that when two or more R³ or R⁴ groups are present, they may be the same or different;
(II) a compound (B2-2) that has, in the molecule, one or more of at least one type of functional group (x1) selected from the group consisting of a cyclic ether group, a (thio)carbonyl group, and an iso(thio)cyanate group, and one or more of a group (x2) different from the functional group (x1), which contains no active hydrogen, but contains at least one selected from the group consisting of a nitrogen atom, a phosphorus atom, an oxygen atom, and a sulfur atom, provided that at least one of the nitrogen, phosphorus, and sulfur atoms may be protected by a trisubstituted hydrocarbylsilyl group; and
(III) a compound (B2-3) having two or more iso(thio)cyanate groups in the molecule. Each of these compounds (B2) may be used alone, or two or more of these compounds (B2) may be used in combination. Herein, the (thio)carbonyl group refers to a carbonyl group and a thiocarbonyl group; and the iso(thio)cyanate group refers to an isocyanate group and an isothiocyanate group.

The hydrocarbyl group for R³ and R⁴ in Formula (1) is preferably a linear or branched C1-C20 alkyl group, a C3-C20 cycloalkyl group, or a C6-C20 aryl group.

R⁵ is preferably a linear or branched C1-C20 alkanediyl group, a C3-C20 cycloalkylene group, or a C6-C20 arylene group.

Preferably, n is 0 or 1 in order to increase the reactivity with the styrene-butadiene copolymer (SBR).

A¹ contains at least one selected from the group consisting of a nitrogen atom, a phosphorus atom, and a sulfur atom (hereinafter, also referred to as specific atom), and is bound to R⁵ through the specific atom. The specific atom is bound to no active hydrogen, and may be protected by, for example, a trisubstituted hydrocarbylsilyl group. The term “active hydrogen” herein refers to a hydrogen atom bound to an atom other than a carbon atom, and preferably refers to a hydrogen atom having a lower bond energy than the carbon-hydrogen bond of polymethylene.

Preferably, A¹ is a group that can be converted to an onium ion by the action of an onium salt-forming agent, among others. The compound (B2) containing such a group (A¹) can impart excellent shape-retaining properties to the modified styrene-butadiene copolymer (SBR).

Specific examples of A¹ include a nitrogen-containing group in which two hydrogen atoms of a primary amino group are substituted by two protecting groups; a nitrogen-containing group in which one hydrogen atom of a secondary amino group is substituted by one protecting group; a tertiary amino group; an imino group; a pyridyl group; a phosphorus-containing group in which two hydrogen atoms of a primary phosphino group are substituted by two protecting groups; a phosphorus-containing group in which one hydrogen atom of a secondary phosphino group is substituted by one protecting group; a tertiary phosphino group; and a sulfur-containing group in which one hydrogen atom of a thiol group is substituted by one protecting group. Among these, groups containing a nitrogen atom are preferred because they have good affinity with silica. The term “protecting group” refers to a functional group that converts A¹ to a functional group inert to the polymerization active terminal, for example, a trisubstituted hydrocarbylsilyl group.

Specific examples of the compound (B2-1) include compounds containing both an alkoxysilyl group and a nitrogen-containing group in which two hydrogen atoms of a primary amine are substituted by two protecting groups, a nitrogen-containing group in which one hydrogen atom of a secondary amine is substituted by one protecting group, or a tertiary amino group, such as N,N-bis(trimethylsilyl)aminopropyltrimethoxysilane, N,N-bis(trimethylsilyl)aminopropylmethyldiethoxysilane, N,N′,N′-tris(trimethylsilyl)-N-(2-aminoethyl)-3-aminopropyltriethoxysilane, or 3-(4-trimethylsilyl-1-piperazino)propylmethyldimethoxysilane.

Examples of compounds containing both an alkoxysilyl group and an imino group or a pyridyl group include N-(1,3-dimethylbutylidene)-3-(triethoxysilyl)-1-propaneamine, N-(1-methylpropylidene)-3-(triethoxysilyl)-1-propaneamine, N-(4-N,N-dimethylaminobenzylidene)-3-(triethoxysilyl)-1-propaneamine, N-(cyclohexylidene)-3-(triethoxysilyl)-1-propaneamine, and trimethoxysilyl, methyldiethoxysilyl, or ethyldimethoxysilyl compounds corresponding to the foregoing triethoxysilyl compounds, N-(3-trimethoxysilylpropyl)-4,5-dihydroimidazole, N-(3-triethoxysilylpropyl)-4,5-dihydroimidazole, N-(3-trimethoxysilylpropyl)-4,5-imidazole, N-(3-triethoxysilylpropyl)-4,5-imidazole, 3-hexamethyleneiminopropyltrimethoxysilane, 3-hexamethyleneiminopropylmethyldimethoxysilane, and the foregoing compounds whose alkyl group and alkanediyl group are replaced with a C1-C6 alkyl group and a C1-C6 alkanediyl group, respectively.

Examples of compounds having both an alkoxysilyl group and a phosphorus-containing group in which two hydrogen atoms of a primary phosphino group are substituted by two protecting groups, a phosphorus-containing group in which one hydrogen atom of a secondary phosphino group is substituted by one protecting group, a tertiary phosphino group, or a sulfur-containing group in which one hydrogen atom of a thiol group is substituted by one protecting group include P,P-bis(trimethylsilyl)phosphinopropylmethyldimethoxysilane, P,P-bis(trimethylsilyl)phosphinopropyltrimethoxysilane, 3-dimethylphosphinopropyltrimethoxysilane, 3-dimethylphosphinopropylmethyldimethoxysilane, 3-diphenylphosphinopropyltrimethoxysilane, 3-diphenylphosphinopropyltriethoxysilane, 3-diphenylphosphinopropylmeryldimethoxysilane, S-trimethylsilylmercaptopropylmethyldimethoxysilane, S-trimethylsilylmercaptopropyltrimethoxysilane, S-trimethylsilylmercaptopropyltriethoxysilane, S-trimethylsilylmercaptopropylmethyldiethoxysilane, and the foregoing compounds whose alkyl group and alkanediyl group are replaced with a C1-C6 alkyl group and a C1-C6 alkanediyl group, respectively. In addition, examples of compounds containing an iso(thio)cyanate group include 3-isocyanatopropyltrimethoxysilane and 3-isocyanatopropyltriethoxysilane.

In the compound (B2-2), the group (x2) is preferably a group that contains a nitrogen atom bound to no active hydrogen, and specific examples of such compounds include:
compounds containing a cyclic ether group, such as epoxy amine compounds, e.g. tetraglycidyl-1,3-bisaminomethyl-cyclohexane,
compounds containing a (thio)carbonyl group, such as 4-aminoacetophenones, e.g. 4-N,N-dimethylaminobenzophenone; bis(dihydrocarbylaminoalkyl)ketones, e.g. 1,7-bis(methylethylamino)-4-heptanone; dihydrocarbyl-aminoalkyl (meth)acrylates, e.g. 2-dimethylaminoethyl acrylate; hydrocarbylimidazolidinones, e.g. 1,3-dimethyl-2-imidazolidinone; N-hydrocarbylpyrrolidones, e.g. 1-phenyl-2-pyrrolidone; N-hydrocarbylcaprolactams, e.g. N-methyl-e-caprolactam; N-dihydrocarbylformamides, e.g. N,N-diethylformamide; N,N-dihydrocarbylacetamides, e.g. N,N-dimethylacetamide; and (meth)acrylamides, e.g. N,N-dimethylacrylamide, and
compounds containing an iso(thio)cyanate group, e.g. 3-isocyanatopropyltrimethoxysilane.

Examples of the compound (B2-3) include 2,4-tolylene diisocyanate, 2,6-tolylene diisocyanate, diphenylmethane diisocyanate, naphthalene diisocyanate, triphenylmethane triisocyanate, p-phenylene diisocyanate, tris(isocyanatophenyl)thiophosphate, xylene diisocyanate, benzene-1,2,4-triisocyanate, naphthalene-1,2,5,7-tetraisocyanate, and 1,4-phenylene diisothiocyanate.

In particular, the compound (B2-1) is preferably used as the compound (B2) because it has high affinity with silica. When a silane compound (B2-1) is used, silicon tetrachloride or an epoxy-containing compound such as tetraglycidyl-1,3-bisaminomethylcyclohexane, for example, may be used with the silane compound (B2-1) to control the Mooney viscosity of the modified styrene-butadiene copolymer (SBR). The compounds (B2) mentioned above all have the same function in that they allow the resulting modified styrene-butadiene copolymer (SBR) to have a modified polymerization terminating terminal. Accordingly, those which are not disclosed in the Examples later can also be used in the present invention. A structure represented by Formula (1-1) below is introduced to the polymer terminal by a reaction between the compound represented by Formula (1) and the modified styrene-butadiene copolymer (SBR).

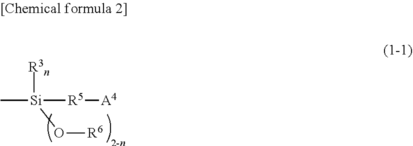

wherein R⁶ represents a hydrogen atom or a hydrocarbyl group, and when two or more R⁶ groups are present, they may be the same or different; and A⁴, R³, R⁵ and n are as defined for A¹, R³, R⁵ and n, respectively, in Formula (1).

The terminal modification reaction may be carried out as a solution reaction. The solution reaction may be carried out using a solution containing unreacted monomers obtained after completion of the polymerization reaction in the above polymerization step, or may be carried out after the styrene-butadiene copolymer (SBR) is isolated from the above solution and dissolved in an appropriate solvent such as cyclohexane. The terminal modification reaction may be carried out either batchwise or continuously. Here, the compound (B2) may be added by any method, for example, at one time, in portions, or continuously.

The amount of the compound (B2) used in the terminal modification reaction may be selected appropriately according to the type of compound used in the reaction. The amount of the compound (B2) is preferably 0.1 mole equivalents or more, more preferably 0.3 mole equivalents or more relative to the metal atom in the polymerization initiator which is involved in the polymerization reaction. When 0.1 mole equivalents or more of the compound (B2) is used, the modification reaction can proceed sufficiently, and the dispersibility of silica can be suitably improved.

The temperature of the terminal modification reaction is usually the same as the temperature of the polymerization reaction, and is preferably −20° C. to 150° C., more preferably 0° C. to 120° C., particularly preferably 20° C. to 100° C. When the temperature of the modification reaction is low, the viscosity of the modified styrene-butadiene copolymer (SBR) tends to increase, while when the temperature of the modification reaction is high, the polymerization active terminal can be easily deactivated. The duration of the modification reaction is preferably one minute to five hours, and more preferably two minutes to one hour.

### (Termination of Reaction)

The anionic polymerization can be terminated by addition of a reaction terminator usually used in this technical field. Examples of the reaction terminator include polar solvents containing active protons, for example, acetic acid and alcohols such as methanol, ethanol, or isopropanol, and mixtures of the foregoing. Other examples include mixtures of the foregoing polar solvents and non-polar solvents such as hexane or cyclohexane. Usually, the amount of the reaction terminator to be added is sufficient when it is about equal to or twice the molar amount of the initiator for anionic polymerization.

### <Coupling>

In the method for producing the styrene-butadiene copolymer (SBR), a coupling agent may be added to a solution of the styrene-butadiene copolymer (SBR) in a hydrocarbon at any time from the initiation of the polymerization of monomers until the polymer is recovered as described later. Examples of the coupling agent include compounds represented by the following Formula (2-1):

R¹ₐML₄₋ₐ (2-1)

wherein R¹ represents an alkyl group, an alkenyl group, a cycloalkenyl group, or an aryl group; M represents a silicon atom or a tin atom; L represents a halogen atom or a hydrocarbyloxy group; and a represents an integer of 0 to 2.

Examples of the coupling agent represented by Formula (2-1) include silicon tetrachloride, methyltrichlorosilane, dimethyldichlorosilane, trimethylchlorosilane, tin tetrachloride, methyltrichlorotin, dimethyldichlorotin, trimethylchlorotin, tetramethoxysilane, methyltrimethoxysilane, dimethoxydimethylsilane, methyltriethoxysilane, ethyltrimethoxysilane, dimethoxydiethylsilane, diethoxydimethylsilane, tetraethoxysilane, ethyltriethoxysilane, and diethoxydiethylsilane.

In order to improve the processability of the polymer, the amount of the coupling agent to be added is preferably 0.03 mol or more, and more preferably 0.05 mol or more, per mol of the alkali metal derived from an alkali metal catalyst. In order to enhance fuel economy, the amount is preferably 0.4 mol or less, and more preferably 0.3 mol or less.

### <Hydrogenation Method>

In the method for producing the hydrogenated copolymer (hydrogenated SBR), the styrene-butadiene copolymer (SBR) described above is hydrogenated to obtain a hydrogenated copolymer (hydrogenated SBR) having a hydrogenation rate of 90 mol % or more. The hydrogenation of the styrene-butadiene copolymer (SBR) advantageously improves heat resistance. When the hydrogenation rate is low, sufficient rubber tensile strength and abrasion resistance cannot be obtained.

The hydrogenation may be carried out by any method under any reaction condition, including known methods and known conditions. Usually, the hydrogenation is carried out at 20° C. to 150° C. under 0.1 to 10 MPa hydrogen pressure in the presence of a hydrogenation catalyst. The degree of hydrogenation may be set appropriately by changing, for example, the amount of the hydrogenation catalyst, the hydrogen pressure during the hydrogenation reaction, or the duration of the reaction. The hydrogenation catalyst used may be usually a compound containing any of the metals of groups 4 to 11 of the periodic table. For example, compounds containing any of Ti, V, Co, Ni, Zr, Ru, Rh, Pd, Hf, Re, and Pt atoms can be used as the hydrogenation catalyst. More specific examples of the hydrogenation catalyst include metallocene compounds containing Ti, Zr, Hf, Co, Ni, Pd, Pt, Ru, Rh, Re, or other metals; supported heterogeneous catalysts in which a metal such as Pd, Ni, Pt, Rh, or Ru is supported on a carrier such as carbon, silica, alumina, or diatomaceous earth; homogeneous Ziegler catalysts in which an organic salt or acetylacetone salt of a metal element such as Ni or Co is combined with a reducing agent such as an organoaluminum; organometallic compounds or complexes of Ru, Rh, or other metals; and fullerenes and carbon nanotubes in which hydrogen is stored.

Among the above exemplary compounds, metallocene compounds containing Ti, Zr, Hf, Co, or Ni are preferred because then the hydrogenation reaction can be carried out in a homogeneous system in an inert organic solvent. Furthermore, metallocene compounds containing Ti, Zr, or Hf are preferred. In particular, hydrogenation catalysts obtained by reaction of titanocene compounds and alkyllithiums are preferred because such catalysts are inexpensive and industrially very useful. Specific examples include hydrogenation catalysts described in, for example, JP H1-275605 A, JP H5-271326 A, JP H5-271325 A, JP H5-222115 A, JP H11-292924 A, JP 2000-37632 A, JP S59-133203 A, JP S63-5401 A, JP S62-218403 A, JP H7-90017 A, JP S43-19960 B, and JP S47-40473 B. Each of these hydrogenation catalysts may be used alone, or two or more of these may be used in combination.

The content of the hydrogenated copolymer (hydrogenated SBR) in 100 parts by mass of the rubber component is 90 parts by mass or more, more preferably 95 parts by mass or more, and further preferably 100 parts by mass.

Examples of other rubbers that may be used in addition to the hydrogenated copolymer (hydrogenated SBR) include conventional styrene-butadiene copolymer rubber (SBR), polybutadiene rubber (BR), butadiene-isoprene copolymer rubber, and butyl rubber. Other possible examples include natural rubber (NR), ethylene-propylene copolymers, and ethylene-octene copolymers. Two or more of these rubbers may be used in combination.

The rubber composition for tires of the present invention further contains 50 parts by mass or more of a filler based on 100 parts by mass of the rubber component. The term “filler” herein refers to a material that may be incorporated in the rubber composition for tires to reinforce rubber. Examples thereof include silica, calcium carbonate, mica including sericite, aluminum hydroxide, magnesium oxide, magnesium hydroxide, clay, talc, alumina, titanium oxide, or white fillers such as mica; and carbon black. Two or more of these fillers may be used in combination. The content of filler is preferably 200 parts by mass or less, and more preferably 150 parts by mass or less, based on 100 parts by mass of the rubber component. In this specification, the rubber composition for tires preferably contains silica as a filler.

The silica is not particularly limited, and examples of the silica include dry silica (anhydrous silica) and wet silica (hydrous silica). Wet silica is preferred as it contains a large amount of silanol groups.

The silica preferably has a nitrogen adsorption specific surface area (N₂SA) of 45 m²/g or more, more preferably 55 m²/g or more, still more preferably 60 m²/g or more, particularly preferably 100 m²/g or more, and most preferably 150 m²/g or more. When the N₂SA is less than 45 m²/g, abrasion resistance or rubber tensile strength may deteriorate. The N₂SA of the silica is also preferably 350 m²/g or less, more preferably 300 m²/g or less, still more preferably 270 m²/g or less, and particularly preferably 220 m²/g or less. When the N₂SA is more than 350 m²/g, it may be difficult to disperse such silica, and fuel economy may deteriorate. Note that the nitrogen adsorption specific surface area of silica is a value measured by the BET method according to ASTM D3037-81.

The content of silica is preferably 40 parts by mass or more, more preferably 50 parts by mass or more, and further preferably 80 parts by mass or more, based on 100 parts by mass of the rubber component. Abrasion resistance can be improved by making the content to 40 parts by mass or more. The content of the silica is preferably 200 parts by mass or less, more preferably 170 parts by mass or less, and further preferably 150 parts by mass or less. Processability can be improved by making the content to 200 parts by mass or less.

The content of silica in 100% by mass of the filler is preferably 80% by mass or more, and more preferably 90% by mass or more. If it is less than 80% by mass, there is a risk that the effect of incorporating silica may not be sufficiently obtained. Further, in this case, if carbon black is used as the remaining filler, wet grip performance tends to deteriorate. Furthermore, if a filler other than carbon black is used, there is a risk that the abrasion resistance will deteriorate.

In the rubber composition for tires in the present specification, it is preferable to use a silane coupling agent together with silica. By blending silica and a silane coupling agent with the hydrogenated copolymer (hydrogenated SBR), a good crosslinked network can be formed.

As the silane coupling agent, conventionally known ones can be used, and examples thereof include: sulfide-based silane coupling agents such as bis(3-triethoxysilylpropyl)tetrasulfide, bis(2-triethoxysilylethyl)tetrasulfide, bis(3-trimethoxysilylpropyl)tetrasulfide, bis(2-trimethoxysilylethyl)tetrasulfide, bis(3-triethoxysilylpropyl)trisulfide, bis(3-trimethoxysilylpropyl)trisulfide, bis(3-triethoxysilylpropyl)disulfide, bis(3-trimethoxysilylpropyl)disulfide, 3-trimethoxysilylpropyl-N,N-dimethylthiocarbamoyltetrasulfide, 3-trimethoxysilylpropylbenzothiazolyltetrasulfide, 3-triethoxysilylpropylbenzothiazoletetrasulfide, 3-triethoxysilylpropyl methacrylate monosulfide, and 3-trimethoxysilylpropyl methacrylate monosulfide; mercapto silane coupling agents such as 3-mercaptopropyltrimethoxysilane, 3-mercaptopropyltriethoxysilane, 2-mercaptoethyltrimethoxysilane, and 2-mercaptoethyltriethoxysilane; vinyl silane coupling agents such as vinyltriethoxysilane and vinyltrimethoxysilane; amino silane coupling agents such as 3-aminopropyltriethoxysilane, 3-aminopropyltrimethoxysilane, 3-(2-aminoethyl)aminopropyltriethoxysilane, and 3-(2-aminoethyl)aminopropyltrimethoxysilane; glycidoxy silane coupling agents such as γ-glycidoxypropyltriethoxysilane, γ-glycidoxypropyltrimethoxysilane, γ-glycidoxypropylmethyldiethoxysilane, and γ-glycidoxypropylmethyldimethoxysilane; nitro silane coupling agents such as 3-nitropropyltrimethoxysilane and 3-nitropropyltriethoxysilane; and chloro silane coupling agents such as 3-chloropropyltrimethoxysilane, 3-chloropropyltriethoxysilane, 2-chloroethyltrimethoxysilane, and 2-chloroethyltriethoxysilane. Each of these silane coupling agents may be used alone, or two or more of these may be used in combination. In view of the coupling effect of silane coupling agents, processability, and cost, sulfide-based silane coupling agents are preferred among these, with bis(3-triethoxysilylpropyl)tetrasulfide or bis(3-triethoxysilylpropyl)disulfide being more preferred.

The content of the silane coupling agent based on 100 parts by mass of silica is preferably 3 parts by mass or more, more preferably 5 parts by mass or more. A content of less than 3 parts by mass tends to have an insufficient coupling effect and also tends not to allow for high dispersion of silica. As a result, fuel economy or rubber tensile strength may be reduced. The content of the silane coupling agent relative to 100 parts by mass of silica is also preferably 15 parts by mass or less, more preferably 10 parts by mass or less. When the content is more than 15 parts by mass, excess silane coupling agents may be left in the rubber composition, leading to reduction in the processability and tensile properties of the rubber composition for tires.

The rubber composition for tires in the present specification may contain carbon black, if necessary. When carbon black is contained, examples of the carbon black include furnace black (furnace carbon black) such as SAF, ISAF, HAF, MAF, FEF, SRF, GPF, APF, FF, CF, SCF or ECF; acetylene black (acetylene carbon black); thermal black (thermal carbon black) such as FT or MT; channel black (channel carbon black) such as EPC, MPC or CC; and graphite. Each of these may be used alone, or two or more of these may be used in combination.

The carbon black usually has a nitrogen adsorption specific surface area (N₂SA) of 5 to 200 m²/g. The lower limit is preferably 50 m²/g, more preferably 80 m²/g, while the upper limit is preferably 150 m²/g, more preferably 120 m²/g. The carbon black usually has a dibutyl phthalate (DBP) absorption of 5 to 300 mL/100 g. The lower limit is preferably 80 mL/100 g, while the upper limit is preferably 180 mL/100 g. Carbon black having an N₂SA or DBP absorption of less than the lower limit indicated above tends to have only a small reinforcing effect, resulting in reduced abrasion resistance. Carbon black having an N₂SA or DBP absorption of more than the upper limit indicated above tends to disperse poorly, resulting in increased hysteresis loss and reduced fuel economy.

The nitrogen adsorption specific surface area is measured in accordance with ASTM D4820-93. The DBP absorption is measured in accordance with ASTM D2414-93.

The content of carbon black based on 100 parts by mass of the rubber component is preferably 1 part by mass or more, more preferably 3 parts by mass or more. When the content is less than 1 part by mass, sufficient reinforcing properties may not be obtained. The content of carbon black is preferably 60 parts by mass or less, more preferably 30 parts by mass or less, still more preferably 15 parts by mass or less. When the content is more than 60 parts by mass, fuel economy tends to deteriorate.

The rubber composition for tires in the present invention contains 10 parts by mass or more of a plasticizer. The content of the plasticizer is preferably 150 parts by mass or less, and more preferably 120 parts by mass or less, based on 100 parts by mass of the rubber component. The blending amount of the plasticizer is preferably 50% or more and more preferably 150% or less of the blending amount of filler. Examples of the plasticizer include oil, resin, and liquid rubber. Among them, resin is preferable. Examples of the resin include styrene-based resins, coumaron indene resins, indene resins, terpene resins, and rosin resins. These may be used alone or in combination of two or more. Among these, styrene-based resins are preferred because they have good tackiness when unvulcanized and good fuel efficiency.

Styrenic resin (styrene-based resin) is a resin obtained by polymerizing monomers having a styrene skeleton such as styrene and α-methylstyrene, and includes styrene homopolymer, α-methylstyrene homopolymer, copolymer of α-methylstyrene and styrene, etc. Among them, copolymers of α-methylstyrene and styrene are preferred. The coumarone-indene resin refers to a resin containing coumarone and indene as main monomer components forming the skeleton (backbone) of the resin. Examples of monomer components other than coumarone and indene that may be contained in the skeleton include styrene, α-methylstyrene, methylindene, and vinyltoluene. The indene resin refers to a resin containing indene as a main monomer component forming the skeleton (backbone) of the resin. The terpene resin refers to a resin obtained by polymerization of a terpene compound such as α-pinene, β-pinene, camphor, or dipentene; or a terpene-based resin, such as typically terpenephenol formed from a terpene compound and a phenolic compound as starting materials. The rosin resin refers to a rosin-based resin, such as typically natural rosin, polymerized rosins, modified rosins, esterified products of these rosins, or hydrogenated products of these rosins.

The softening point of the resin is, for example, −40° C. or higher and 160° C. or lower. The softening point is preferably 50° C. or higher. Further, the softening point is preferably 130° C. or lower.

In this specification, the softening point is the temperature at which the ball drops when the softening point specified in JIS K 6220-1:2001 is measured using a ring and ball softening point measuring device.

The content of the resin having the specific softening point is preferably 5 parts by mass or more, more preferably 10 parts by mass or more, further preferably 20 parts by mass or more, and further preferably 30 parts by mass or more, based on 100 parts by mass of the rubber component. When the content is 1 part by mass or more, wet grip performance is improved. Further, the content of the resin is preferably 100 parts by mass or less, and more preferably 80 parts by mass or less. By making the content to 100 parts by mass or less, grip performance on snowy roads can be improved.

Examples of the oil include mineral oil, vegetable oil, and animal oil. Examples of liquid rubber include liquid isoprene rubber, liquid butadiene rubber, and liquid styrene-butadiene rubber.

In addition to the above components, the rubber composition for tires in the present specification may contain compounding agents conventionally used in the rubber industry. Examples include vulcanizing agents such as sulfur; vulcanization accelerators such as thiazole vulcanization accelerators, thiuram vulcanization accelerators, sulfenamide vulcanization accelerators, and guanidine vulcanization accelerators; vulcanization activators such as stearic acid and zinc oxide; organic peroxides; processing aids such as lubricants; and anti-aging agents.

Examples of anti-aging agents include naphthylamine-based anti-aging agents such as phenyl-α-naphthylamine; diphenylamine-based anti-aging agents such as octylated diphenylamine and 4,4′-bis(α,α′-dimethylbenzyl) diphenylamine; amines; quinoline anti-aging agents such as polymers of ketone condensation type 2,2,4-trimethyl-1,2-dihydroquinoline; monophenol-based anti-aging agents such as 2,6-di-t-butyl-4-methylphenol, and styrenated phenol; and bis-, tris-, polyphenol-based anti-aging agents such as tetrakis-[methylene-3-(3′,5′-di-t-butyl-4′-hydroxyphenyl)propionate]methane. Note, the rubber composition for tires of the present invention does not contain a PPD compound (PPD anti-aging agent). As commercially available products, for example, products manufactured by Seiko Chemical Co., Ltd., Sumitomo Chemical Co., Ltd., Ouchi Shinko Chemical Industry Co., Ltd., Flexsys Co., Ltd., etc. can be used. These may be used alone or in combination of two or more.

As the anti-aging agent, it is preferable to use an amine-ketone condensation compound. The content of the amine-ketone condensation compound is preferably 0.5 parts by mass or more, and more preferably 0.8 parts by mass or more, based on 100 parts by mass of the rubber component. It is preferably 5 parts by mass or less, more preferably 4 parts by mass or less, and further preferably 3 parts by mass or less. Within the above range, better effects tend to be obtained.

Examples of the vulcanization accelerator include thiazole vulcanization accelerators such as 2-mercaptobenzothiazole, dibenzothiazyl disulfide, and N-cyclohexyl-2-benzothiazylsulfenamide; thiuram vulcanization accelerators such as tetramethylthiuram monosulfide and tetramethylthiuram disulfide; sulfenamide vulcanization accelerators such as N-cyclohexyl-2-benzothiazolesulfenamide, N-t-butyl-2-benzothiazolesulfenamide, N-oxyethylene-2-benzothiazolesulfenamide, N-oxyethylene-2-benzothiazolesulfenamide, and N,N′-diisopropyl-2-benzothiazolesulfenamide; and guanidine vulcanization accelerators such as diphenylguanidine, diorthotolylguanidine, and orthotolylbiguanidine. Among them, thiuram vulcanization accelerators are preferred. Furthermore, it is also preferable to use a sulfenamide vulcanization accelerator and a guanidine vulcanization accelerator together. The content of the vulcanization accelerator is preferably 0.1 to 5 parts by mass, more preferably 0.2 to 4 parts by mass based on 100 parts by mass of the rubber component.

The vulcanizing agent is not particularly limited, but sulfur can be suitably used. The content of sulfur is preferably 0.5 to 5 parts by mass, more preferably 1 to 3 parts by mass based on 100 parts by mass of the rubber component.

The rubber composition for tires in the present specification is produced by a common method. That is, it can be produced by kneading the above-mentioned components using a Banbury mixer, kneader, open roll, etc., and then vulcanizing the kneaded product.

The rubber composition for tires in the present specification can be used for each member of a tire (tread, sidewall, carcass, belt, bead, etc.), and is especially suitable for treads of tires. In the case of a two-layer tread, it consists of a surface layer (cap tread) and an inner surface layer (base tread).

A multi-layer tread can be produced by forming the rubber composition into a sheet, and assembling the sheets into a predetermined shape, or by feeding the rubber composition into an extruder with two or more screws, and forming it into a two- or more-layered extrudate at the head outlet of the extruder.

The tire of the present invention can be manufactured by a conventional method using the above rubber composition for tires. The tire of the present invention can exhibit sufficient ozone resistance performance. That is, a rubber composition for tires, in which 100 parts by mass of the rubber component contains 90 parts by mass or more of the hydrogenated polymer with a hydrogenation rate of 90 mol % or more, and 50 parts by mass or more of filler and 10 parts by mass of plasticizer are contained with respect to 100 parts by mass of the rubber component, but a PPD-based compound is not contained, is extruded to the shape of each tire member such as a tread at an unvulcanized stage, and then molded with other tire components on a tire molding machine in a conventional manner to form an unvulcanized tire. By heating and pressurizing the unvulcanized tire in a vulcanizer, it is possible to obtain a tire that can exhibit sufficient ozone resistance performance.

The tire thus obtained is suitably used as a tire for a passenger car, a tire for a truck or a bus, a tire for two-wheeled vehicles, a tire for racing, etc., and is particularly suitably used as a tire for a passenger car.

### Example

The present invention will be specifically explained based on Examples, but the present invention is not limited to these.

Below, various chemicals used during synthesis and polymerization will be collectively explained. In addition, chemicals are purified according to standard methods if necessary.
n-Hexane: Manufactured by Kanto Chemical Co., Ltd.
Styrene: Manufactured by Kanto Chemical Co., Ltd.
Butadiene: 1,3-butadiene manufactured by Tokyo Chemical Industry Co., Ltd.
THF: Tetrahydrofuran manufactured by Kanto Kagaku Co., Ltd.
n-Butyllithium solution: 1.6M n-butyllithium hexane solution manufactured by Kanto Chemical Co., Ltd.
2,6-di-tert-butyl-p-cresol: Nocrac 200 manufactured by Ouchi Shinko Chemical Industry Co., Ltd.
Amine modifier: N,N-bis(trimethylsilyl)aminopropylmethyl diethoxysilane

Also, the evaluation method of the obtained styrene-butadiene copolymer (SBR) will be summarized below.

### (Measurement of Hydrogenation Rate of Conjugated Diene Moiety)

A 15% by mass solution of each copolymer in carbon tetrachloride is prepared to measure a ¹H-NMR spectrum at 100 MHz. The hydrogenation rate is calculated from the rate of decrease in the intensity of the ¹H-NMR spectrum corresponding to unsaturated bonds.

### (Measurement of Styrene Content)

A ¹H-NMR spectrum is measured using a JEOL JNM-A 400 NMR device at 25° C. The ratio of phenyl protons of the styrene unit at 6.5 to 7.2 ppm to vinyl protons of the butadiene unit at 4.9 to 5.4 ppm is determined based on the spectrum. The styrene content is calculated from the ratio.

### (Measurement of Weight Average Molecular Weight (Mw))

The weight average molecular weight (Mw) of each styrene-butadiene copolymer (SBR) is determined by gel permeation chromatography (GPC) (GPC-8000 series available from Tosoh Corporation, detector: differential refractometer, column: TSKGEL SUPERMULTIPORE HZ-M available from Tosoh Corporation) relative to polystyrene standards. In the case of styrene-butadiene copolymers (SBR) containing a modifying group, the Mw is measured before the copolymers are modified. This is because the Mw of styrene-butadiene copolymer (SBR) containing a modifying group are not accurately determinable due to interaction between the modifying group and silica gel in the column.

### (Measurement of Glass Transition Temperature (Tg))

The glass transition temperature is measured in accordance with JIS K 7121 using a differential scanning calorimeter (Q200) available from TA instruments Japan Inc. while increasing the temperature at a rate of temperature rise of 10° C./min. The glass transition starting temperature is taken as the glass transition temperature (Tg).

### <Synthesis of Hydrogenated SBR (Hydrogenation Rate 96 Mol %, Styrene Content: 30% by Mass, Mw: 510,000, Tg: −31° C.)>

To a sufficiently nitrogen-purged heat-resistant reaction vessel are charged 2,000 mL of n-hexane, 60 g of styrene, 140 g of 1,3-butadiene, 2.5 g of THF, and 0.45 mmol of n-butyllithium, followed by stirring at 50° C. for 5 hours to cause a polymerization reaction. Thereafter, 0.15 mol of an amine modifying agent is added, and the mixture is stirred for 1 hour. Next, the reaction solution is stirred for 20 minutes while supplying hydrogen gas at a pressure of 0.4 MPa gauge to react the unreacted polymer terminal lithium with hydrogen to form lithium hydride. Hydrogenation is carried out using a titanocene dichloride-based catalyst at a hydrogen gas supply pressure of 0.7 MPa gauge and a reaction temperature of 90° C. Once the cumulative amount of absorbed hydrogen reached the amount corresponding to the target hydrogenation rate, the reaction temperature is brought to room temperature and the hydrogen pressure is returned to an ordinary pressure, and then the reaction solution is drawn from the reaction vessel and introduced into water with stirring. The solvent is removed by steam stripping to obtain the desired hydrogenated SBR.

Below, various chemicals used in Examples and Comparative Examples will be explained.
Hydrogenated SBR: Synthesized using the above method
Non-hydrogenated SBR: HPR850 manufactured by JSR Corporation
Carbon black: Diablack N220 (N₂SA: 114 m²/g) manufactured by Mitsubishi Chemical Corporation
Oil: NH-70S manufactured by Idemitsu Kosan Co., Ltd.
Styrenic resin: SYLVATRAXX4401 manufactured by Clayton Co., Ltd. (Copolymer of α-methylstyrene and styrene, softening point: 85° C., Mw: 520)
Silica: ULTRASIL VN3 manufactured by EVONIK Co., Ltd. (N₂SA: 180 m²/g)
Silane coupling agent: Si 266 manufactured by Degussa Co., Ltd.
Anti-aging agent: Antigen FR manufactured by Sumitomo Chemical Co., Ltd. (a purified reaction product of amine and ketone, with no residual amine, amine-ketone condensation compound)
Stearic acid: Beaded stearic acid Tsubaki manufactured by NOF Corporation
Zinc oxide: Zinc oxide No. 1 manufactured by Mitsui Mining & Smelting Co., Ltd.
Sulfur: 5% oil sulfur
Vulcanization accelerator (1): DPG (1,3-diphenylguanidine), non-thiuram type
Vulcanization accelerator (2): Nocceler-NS (N-tert-butyl-2-benzoylsulfenamide), non-thiuram type
Vulcanization accelerator (3): Suncelar TBzTD (tetrabenzyl-thiuram disulfide) manufactured by Sanshin Chemical Industry Co., Ltd., thiuram type

### Examples and Comparative Examples

According to the formulations shown in Table 1, the materials other than the sulfur and vulcanization accelerators are kneaded for 5 minutes at 150° C. using a 1.7-L Banbury mixer (available from Kobe Steel, Ltd.) to give a kneaded mixture. Next, the sulfur and vulcanization accelerators are added to the kneaded mixture, followed by kneading for 5 minutes at 80° C. using an open roll mill to give an unvulcanized rubber composition. The unvulcanized rubber composition is press-vulcanized for 20 minutes at 170° C. in a 0.5 mm-thick die to obtain a vulcanized rubber composition.

### <Evaluation Items and Test Methods>

The obtained vulcanized rubber composition is subjected to the following ozone resistance evaluation (Dynamic test, Static test).

### (Dynamic Test)

According to JIS K 6259 “Vulcanized rubber and thermoplastic rubber—Determination of ozone resistance”, a test piece of a predetermined size is prepared from a vulcanized rubber composition and subjected to a dynamic ozone deterioration test. By observing the state of cracks after 24 hours of testing under the conditions of a reciprocating motion frequency of 0.5±0.025 Hz, an ozone concentration of 50±5 pphm, a test temperature of 40° C., and a tensile strain of 10±2%, ozone resistance performance (ozone resistance dynamic 24 hours) is evaluated.

### (Static Test)

According to JIS K 6259 “Vulcanized rubber and thermoplastic rubber—Determination of ozone resistance”, a test piece of a predetermined size is prepared from a vulcanized rubber composition and subjected to a static ozone deterioration test. After standing for 72 hours under the conditions of ozone concentration 50±5 pphm, test temperature 40° C., and tensile strain 20±2%, by observing the state of cracks, ozone resistance performance (ozone resistance static 72 hours) is evaluated.

### (Ozone Resistance Evaluation Score)

The following ratings will be given depending on the number of cracks that have occurred and the length of the cracks that have occurred.

If no cracks occur, mark it as ∘.
(1) Number of cracks
∘: No cracks occur
e: Occurs only around edges
A: Several occurrences (less than 10)
B: Small number of occurrences (10 or more but less than 30)
C: Distributed over the entire surface (30 or more but less than 90)
D: Full surface with gaps (90 or more and less than 300)
E: Fully densely packed (more than 300 cracks)
(2) Crack length
1: shorter than 0.1 mm
2: 0.1 mm or longer and shorter than 0.2 mm
3: 0.2 mm or longer and shorter than 0.5 mm
4: 0.5 mm or longer and shorter than 1 mm
5: 1 mm or longer and shorter than 2 mm
6: 2 mm or longer and shorter than 7 mm
7: longer than 7 mm (things that are likely to be cut)

TABLE 1

| | | | Comparative example | | |
|---|---|---|---|---|---|
| Formulation (parts by mass) | | Example | 1 | 2 | 3 |
| Rubber | Hydrogenated SBR | 100 | 0 | 100 | 100 |
| component | Non-hydrogenated SBR | 0 | 100 | 0 | 0 |
| Filler | Carbon black | 5 | 5 | 5 | 5 |
| | Silica | 55 | 55 | 30 | 55 |
| Silane coupling agent | | 4.5 | 4.5 | 4.5 | 4.5 |
| Plasticizer | Styrenic resin | 11 | 11 | 11 | 0 |
| | Oil | 35 | 35 | 35 | 0 |
| Anti-aging | PPD compound | 0 | 0 | 0 | 0 |
| agent | Amine-ketone condensation compound | 1 | 1 | 1 | 1 |
| Vulcanization | Stearic acid | 2 | 2 | 2 | 2 |
| activator | Zinc oxide | 2 | 2 | 2 | 2 |
| Sulfur | | 1 | 1 | 1 | 1 |
| Vulcanization | Vulcanization accelerator (1) | 1 | 1 | 1 | 1 |
| accelerator | Vulcanization accelerator (2) | 1.5 | 1.5 | 1.5 | 1.5 |
| | Vulcanization accelerator (3) | 2 | 2 | 2 | 2 |
| Ozone | Ozone resistant static 72 h | ∘ | D6 | A2 | A3 |
| resistance | Ozone resistant dynamic 24 h | ∘ | D6 | e2 | e2 |
| evaluation | | | | | |

1. A rubber composition for tires comprising
90 parts by mass or more of a hydrogenated polymer with a hydrogenation rate of 90 mol % or more in 100 parts by mass of the rubber component;
50 parts by mass or more of a filler with respect to 100 parts by mass of the rubber component, and
10 parts by mass or more of a plasticizer with respect to 100 parts by mass of the rubber component; wherein
the rubber composition contains no paraphenylenediamine-based compound.

2. The rubber composition for tires according to claim 1, wherein the filler is silica.

3. The rubber composition for tires according to claim 1, wherein the plasticizer is a resin.

4. The rubber composition for tires according to claim 3, wherein the resin is a styrenic resin.

5. The rubber composition for tires according to claim 1, which contains an amine-ketone condensation compound.

6. The rubber composition for tires according to claim 5, wherein the content of the amine-ketone condensation compound is 0.5 parts by mass or more based on 100 parts by mass of the rubber component.

7. A tire which has a member made of the rubber composition for tires according to claim 1.
